(19) United States
(12) Patent Application Publication
(10) Pub. No.: US 2011/0045435 A1
(43) Pub. Date: Feb. 24, 2011

(54) DENTAL PLIERS

(76) Inventor: Phillip Marshall Goodman, Dayton, OH (US)

Correspondence Address: A PATENT LAWYER CORP, PLC;R WILLIAM GRAHAM, 22 S ST CLAIR ST, DAYTON, OH, 45402, US

(21) Appl. No.: 12/545,919

(22) Filed: Aug. 24, 2009

(51) Int. Cl. A61C 3/14; A61C 3/16

(52) U.S. Cl. 433/159

(57) ABSTRACT

A dental pliers includes a pair of opposing jaw parts which generally lie in a first plane, a pair of arms each connected to one of the jaw parts and wherein the arms lie generally outside the first plane, wherein the arms are pivotally connected in a manner such that the jaws are displaced from/restored toward each other as the arms are displaced from/restored toward each other, and a pad connected to at least one of the arms extending toward the first plane.

### BACKGROUND OF THE INVENTION

1. Field of Invention

The present invention relates generally to improved methods and devices for the removal of dental prostheses, such as dental bands and crowns, as well as baby teeth. Traditional methods for the removal of dental crowns include those such as the following.

2. Prior Art

Prior pliers, or other like devices, have been designed for handling dental prostheses. One problem particularly troublesome to dentists is the failure of such pliers to provide dental pliers capable of cleanly removing a band connected to a tooth surface in a manner without driving the band under the gum tissue.

Similarly, the art lacks one dental plier capable of performing multiple functions: i.e. removal of temporary crowns, removal of orthodontic bands, and removal of teeth, particularly loose baby teeth. Prior to this instrument, three separate instruments would be necessary to accomplish the aforementioned tasks.

Accordingly, a dental plier is needed which is capable of removing of temporary crowns, removal of orthodontic bands, and removal of teeth, particularly loose baby teeth which avoids the above-noted problems.

### SUMMARY OF THE INVENTION

It is an object to improve dental pliers.

It is a further object to improve the method of removing bands, temporary crowns, and other appliances used on teeth.

It is yet another object to improve the method of removing teeth, particularly baby teeth.

Another object of the instant invention is to provide dental pliers capable of utilizing a fulcrum effect to aid in the removal of the dental appliances and teeth.

It is an object of this invention to provide improved dental pliers for removing dental prostheses without damaging the same.

Another object of this invention is to provide dental pliers with a removable pad for use on teeth in various sizes and shapes.

Still other objects and advantages of the invention will in part be obvious and will in part be apparent from the specification.

Accordingly, the present invention is directed to dental pliers having a pair of opposing jaw parts which generally lie in a first plane and are each connected to a respective arm which lie generally outside the first plane. Each of the arms can preferably be curved to aid in handling the pliers. The arms can be pivotally connected in a manner such that the jaws are displaced from/restored toward each other as the arms are displaced from/restored toward each other.

Interconnecting each respect jaw and arm pair is an angle portion. The length of the jaw and the length and angle of the angle portion with respect to connection to the respective arm can preferably be such not to exceed an arch length from an incisor edge of a front tooth to a molar.

Connected to and extending laterally inwardly from each forward end is a gripper flange which can preferably include a terminating serrated edge. The width can be of a length of between 2.5 and 3.2 mm and preferably 2.8-3.0 mm to aid in grasping underneath a band, bracket or other appliance. The flange can preferably be wide enough to enable gripping a tooth, such as a temporary crown or baby tooth.

Connected to an underside of one of the plier joints is a polyurethane pad which can preferably be autoclaved and held in place by a friction fit. The polyurethane can preferably be a durometer of 30 to 60, preferably 40.

In one embodiment, the pad can include a stretchable tube which is stretched about the plier and in another embodiment the pad can also be held on the plier joint by 4 parallel pins. It is contemplated that the hardness is preferably such to permit comfort and protection of the tooth/teeth upon which the pad is so located when performing a removal of a dental appliance or tooth.

The invention accordingly comprises the features of construction, combinations of elements, and arrangement of parts which will be exemplified in the constructions hereinafter set forth, and the scope of the invention will be indicated in the claims.

### BRIEF DESCRIPTION OF THE DRAWINGS

For a fuller understanding of the invention, reference is made to the following description taken in connection with the accompanying drawings, in which:

FIG. 1 is a perspective view of dental pliers in accordance with the instant invention;

FIG. 2 is a top plan view of the pliers of the embodiment of FIG. 1;

FIG. 3A is a side view of FIG. 1;

FIG. 3B is a side view of an alternative embodiment; and

FIG. 4 is a bottom plan view of the pliers of the embodiment of FIG. 1.

### DESCRIPTION OF THE PREFERRED EMBODIMENTS

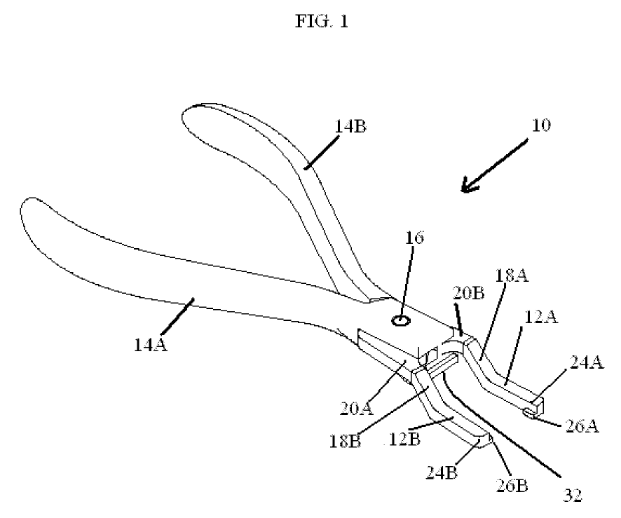

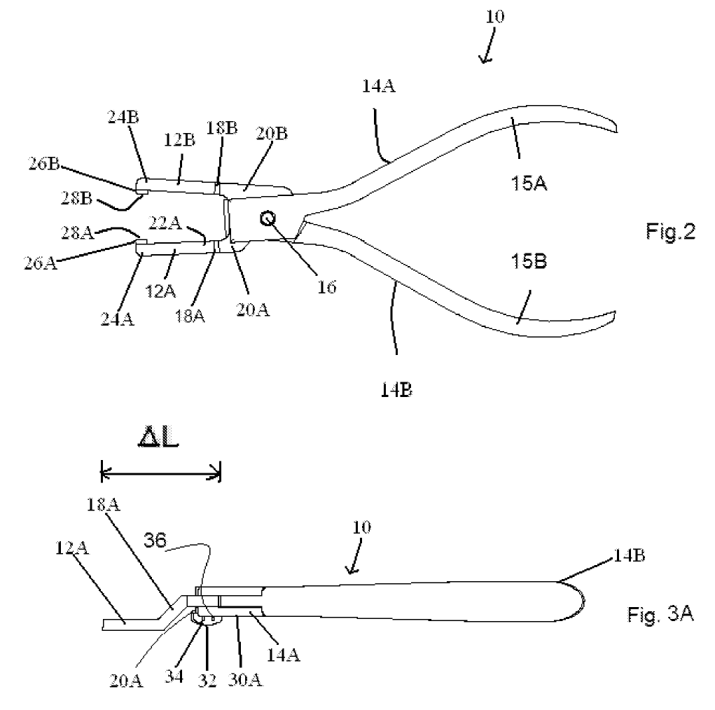

Referring now to FIG. 1, dental pliers of the present invention is generally designated by the numeral 10. The preferred material for the construction of the pliers 10 is surgical stainless steel, except for parts otherwise discussed hereinafter. This permits pliers 10 to be sterilized via an autoclave.

The dental pliers 10 has a pair of opposing jaw parts, 12A and 12B, which generally lie in a first plane P and are each connected to an arm 14A and 14B, respectively, which lie generally outside the first plane P. Each of the arms, 14A and 14b, can preferably be curved at rearward end 15A and 15B to aid in handling the pliers 10. The arms 14A and 14B are pivotally connected about a pivot pin 16 in a manner such that when the jaws 12A and 12B are displaced from/restored toward each other as the arms 14A and 14b are displaced from/restored toward each other.

Interconnecting each jaw 12A-arm14A and jaw 12B-arm14B pair is an angle portion 18A and 18b, respectively. The angle portion 18A connects to a forward end 20A of the arm 14A and back end 22A of jaw 12A and angle portion 18B is similarly connected to a forward end 20B of the arm 14B and back end 22B of jaw 12B. The length of the jaw 14A and length and angle of the angle portion 18A, with respect to connection to the arm 14A, can preferably be such not to exceed an arch length ΔL from an incisor edge of front teeth to a first molar. This length varies between patients but typically is about 1 inch.

Connected to and extending laterally inwardly from each forward end 24A and 24B is a gripper flange 26A and 26B, respectively, and can preferably be fabricated from tungsten carbide. Each gripper flange 26A and 26B can preferably include a terminating serrated edge 28A and 28B, respectively. The width Ax can be of a length of between 2.5 and 3.2 mm and preferably 2.8-3.0 mm to aid in grasping underneath a band, bracket or other appliance. The gripper flanges 26A and 26B can preferably be wide enough to enable gripping a tooth T, such as a temporary crown or baby tooth.

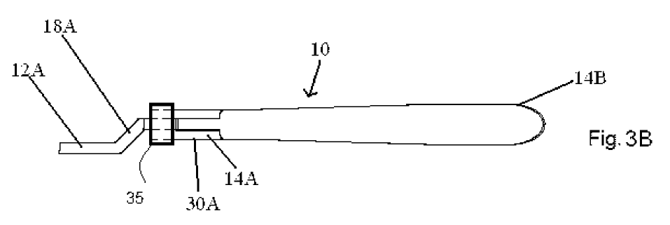

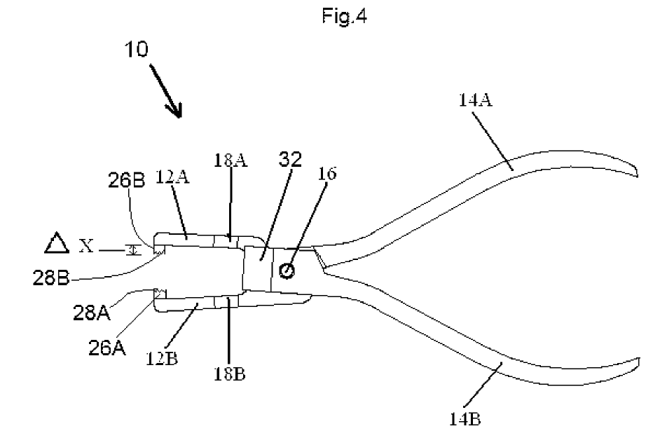

As seen in FIG. 3A, connected to an underside 30A of arm 14A is a pad 32. The pad 32 can preferably be removably connected to the arm 14A, by way of a friction fit connection. In this regard, pins 34 extend from underside 30A to be frictionally received within pin receiving surfaces 36 of pad 32. The pad 32 can preferably be located adjacent forward end 20A. The pad 32 can be made of a polyurethane material, for example, having a durometer hardness between 30 to 60, but preferably about 40. The pad may be made of rubber or other resilient material that is flexible, pliable and soft, and non-absorbent. The pad 32 can be sterilized in one or more cold or hot methods which can include autoclave. Optionally, the pad 32 can be discarded and replaced with another.

FIG. 3B depicts another embodiment. Here, there is provided a stretchable tube 35 which can serve as a pad circumferentially disposed about the pliers 10. The pad 32 or tube 35 can preferably be autoclavable.

It is contemplated that the hardness is preferably such to permit comfort and protection of the tooth/teeth upon which the pad 32 is so located when performing a removal of a dental appliance D or tooth T.

By virtue of the unique design of the pliers 10 of the instant invention, there is provided an easy to use device and method for removing dental appliances and teeth. Operation of the dental pliers 10 is as follows.

The pliers 10 can be gripped at arms 14A and 14B and inserted into a patient's mouth without requiring significant approach angle and jaws 12A and 12B disposed about and/underneath the appliance or tooth to be removed. When positioning the pliers 10, the pad 32 will necessarily come to rest on one or more adjacent teeth. This pad 32 provides a fulcrum point about which force is dispersed. The pad 32 serves to insure that rotation of the pliers 10 during the step of removal will occur around an axis which is generally at the level of the biting surface of the remaining teeth. Because the pad 32 is of a relatively soft material, the force can be dispersed evenly over the tooth or other teeth in a manner which does not risk damage or breakage while enabling the removal of the desired appliance/tooth.

Once positioned with the gripper flanges 26A and 26B in contact with the item to be removed, only slight leverage is required causing vertical movement of the item with respect to the tooth surface to perform removal.

It will be seen from the objects above and those apparent from the description, that modifications, derivations and improvements can be made without departing from the invention and it is intended that all matter contained in the above description and shown in the accompanying drawings shall be interpreted as illustrative and not in a limiting sense with respect to the claims appended hereto.

What is claimed is:

1. A dental pliers, comprising:
a pair of opposing jaw parts which generally lie in a first plane;
a pair of arms each connected to one of said jaw parts and wherein said arms lie generally outside said first plane, wherein said arms are pivotally connected in a manner such that said jaws are displaced from/restored toward each other as the arms are displaced from/restored toward each other; and
a pad connected to at least one of said arms extending toward said first plane.

2. The dental pliers of claim 1, wherein said pad is removably connected to said arm.

3. The dental pliers of claim 2, wherein a pin extends from said underside and friction fits into a pin receiving surface of said pad.

4. The dental pliers of claim 1, wherein each of said arms is curved.

5. The dental pliers of claim 1, which includes an angle portion interconnecting each said jaw and arm pair.

6. The dental pliers of claim 1, wherein a length of said jaw and a length and an angle of said angle portion does not to exceed an arch length from an incisal edge of a front tooth to a molar.

7. The dental pliers of claim 1, which includes a gripper flange connected to and extending laterally inwardly from a forward end of each said jaw and includes a terminating serrated edge.

8. The dental pliers of claim 7, wherein the width is between 2.5 and 3.2 mm.

9. The dental pliers of claim 7, wherein the width is between 2.8-3.0 mm.

10. The dental pliers of claim 1, wherein said pad is disposed adjacent a forward end of the arm.

11. The dental pliers of claim 1, wherein said pad is made of polyurethane having durometer hardness of between 30 to 60.

12. The dental pliers of claim 1, wherein said pad is in the form of a stretchable tube about said pliers.

13. A dental pliers, comprising:
a pair of opposing jaw parts which generally lie in a first plane;
a pair of arms each connected to one of said jaw parts and wherein said arms lie generally outside said first plane, wherein said arms are pivotally connected in a manner such that said jaws are displaced from/restored toward each other as the arms are displaced from/restored toward each other;
a gripper flange connected to and extending laterally inwardly from a forward end of each said jaw and includes a terminating serrated edge; and
a pad connected to at least one of one of said arms extending toward said first plane.

14. The dental pliers of claim 13, wherein said pad is removably connected to said arm.

15. The dental pliers of claim 13, wherein a pin extends from said underside and friction fits into a pin receiving surface of said pad.

16. The dental pliers of claim 13, wherein each of said arms is curved.

17. The dental pliers of claim 13, which includes an angle portion interconnecting each said jaw and arm pair.

18. The dental pliers of claim 17, wherein a length of said jaw and a length and an angle of said angle portion does not exceed an arch length from an edge of a front tooth to a first molar.

19. The dental pliers of claim 13, wherein the width is between 2.5 and 3.2 mm.

20. The dental pliers of claim 13, wherein the width is between 2.8-3.0 mm.

21. The dental pliers of claim 13, wherein said pad is disposed adjacent a forward end of said arm.

22. The dental pliers of claim 13, wherein said pad is made of polyurethane having a durometer hardness of between 30 to 60.

23. The dental pliers of claim 13, wherein said pad is in the form of a stretchable tube about said pliers.
